(19) United States
(12) Patent Application Publication
(10) Pub. No.: US 2005/0258390 A1
(43) Pub. Date: Nov. 24, 2005

(54) Valve system

(75) Inventors: Frank J. Stier, Oak Creek, WI (US); Bruce R. Schultz, West Allis, WI (US)

Correspondence Address: FOLEY & LARDNER, 777 EAST WISCONSIN AVENUE, SUITE 3800, MILWAUKEE, WI, 53202-5308, US

(73) Assignee: Johnson Controls Technology Company

(21) Appl. No.: 10/848,297

(22) Filed: May 18, 2004

(51) Int. Cl. F16K 31/00

(52) U.S. Cl. 251/335.2

(57) ABSTRACT

A system for regulating fluids may comprise a valve including a housing and a valve stem, a first diaphragm positioned proximate a first end of the valve and having a first sealing ring, and a first compression insert configured to threadably couple to the housing of the valve. The housing of the valve is configured to receive at least a portion of the first sealing ring and the first compression insert is configured to compress the first sealing ring received within the housing of the valve by coupling to the housing of the valve.

### BACKGROUND

The present invention relates generally to the field of control valves for regulating fluids. More specifically, the present invention relates to a high pressure valve system having an integrated diaphragm for regulating fluids such as water.

Typically, a water regulating valve controls the quantity of circulating water flowing through a refrigerant condenser. The water regulating valve is actuated by the refrigerant pressure in the compressor discharge line. This pressure acts upon a bellows that transmits motion to the valve stem. The valve maintains a constant refrigerant condensing pressure by controlling the water flow through the condenser. By sensing the refrigerant pressure, the valve permits only enough water through the condenser to condense the amount of refrigerant vapor coming from the compressor. The quantity of water required to condense a given amount of refrigerant varies with changing conditions. Thus, the flow of cooling water through the condenser is automatically maintained at the rate actually required to condense the refrigerant under varying conditions of load and temperature.

Common types of regulating valves often use diaphragm seals that include one or more flat diaphragms compressed against the valve body by a plate. Screws may be used to simultaneously compress the diaphragm(s) as well as fasten a spring housing and pressure elements to the valve body. However, many of these types of systems can be unreliable. For example, there may be uneven clamping force on the diaphragm, high sensitivity to manufacturing settings, high variability in diaphragm compression and subsequent sealing ability, as well as dependence on torque and relaxation of clamping members. This can increase costs and produce intermittent quality problems.

Accordingly, there exists a need for a regulating valve system that is more reliable than many known systems. For example, it is desirable to provide a valve system having a more even clamping force applied to the diaphragm. In addition, there exists a need for a regulating valve system that is less sensitive to manufacturing variances and less sensitive to diaphragm relaxation. Further, there exists a need for a regulating valve system that is less dependent on screw torque settings which often change over time. There also exists a need for a regulating valve system that does not rely on a stamped metal sheet to evenly compress a flat diaphragm. Furthermore, there exists a need for a regulating valve that allows the service of the refrigerant side of a system without affecting the waterside of the system (e.g., that allows the removal of a spring element or pressure element from the valve system without disrupting the diaphragm or seals).

It would be advantageous to provide a system or the like of a type disclosed in the present application that provides any one or more of these or other advantageous features. The present invention further relates to various features and combinations of features shown and described in the disclosed embodiments. Other ways in which the objects and features of the disclosed embodiments are accomplished will be described in the following specification or will become apparent to those skilled in the art after they have read this specification. Such other ways are deemed to fall within the scope of the disclosed embodiments if they fall within the scope of the claims which follow.

### SUMMARY

One embodiment of the present invention relates to a system for regulating fluids. The system comprises a valve comprising a housing and a valve stem, a diaphragm positioned proximate a first end of the valve and having a first sealing ring, and a first compression insert configured to threadably couple to the housing of the valve. The housing of the valve is configured to receive at least a portion of the first sealing ring and the first compression insert is configured to compress the first sealing ring received within the housing of the valve by coupling to the housing of the valve.

Another embodiment of the present invention relates to a system for regulating fluids. The system comprises a valve comprising a housing and a valve stem, a diaphragm positioned proximate a first end of the valve and having a first sealing ring, and a seat nut coupled to the valve stem and configured to receive at least a portion of the first sealing ring. The guide nut is configured to compress the first sealing ring received within the seat nut by coupling to the seat nut.

Another embodiment of the present invention relates to a system for regulating fluids. The system comprises a valve comprising a housing and a valve stem, a diaphragm positioned proximate a first end of the valve and having a first sealing ring, a first compression insert configured to threadably couple to the housing of the valve, and a push rod configured to threadably couple to the valve stem. The diaphragm comprises a first sealing ring, the valve stem is configured to receive at least a portion of the first sealing ring, and the push rod is configured to compress the first sealing ring received within the valve stem by coupling to the valve stem.

Another embodiment of the present invention relates to a system for regulating fluids. The system comprises a valve comprising a housing and a valve stem configured to regulate fluid flow through the valve, a first diaphragm positioned proximate a first end of the valve and having a first sealing portion and a second sealing portion, a first fastener configured to couple to the housing of the valve and compress the first diaphragm against the housing of the valve and form a first seal at the first sealing portion, and a second fastener configured to couple to a first extension of the valve stem and compress the first diaphragm against the first extension of the valve stem and form a second seal at the second sealing portion.

Another embodiment of the present invention relates to a system for regulating fluids. The system comprises a valve comprising a housing and a valve stem configured to regulate fluid through the valve, a diaphragm positioned proximate a first end of the valve and having a first sealing portion and a second sealing portion, a first fastener configured to couple to the housing of the valve and compress the diaphragm against the housing of the valve and form a first seal at the first sealing portion, and a second fastener configured to couple to an extension of the valve stem and compress the diaphragm against the extension of the valve stem and form a second seal at the second sealing portion.

Another embodiment of the present invention relates to a method for producing a valve system that forms a seal without attachment of a pressure element and spring element. The method comprises providing a valve having a housing and a valve stem configured toregulate fluid flow through the valve, providing a first diaphragm positioned proximate a first end of the valve and having a first sealing ring and a second sealing ring, providing a first fastener configured to couple to the housing of the valve and compress the first diaphragm against the housing of the valve and form a first seal at the first sealing ring, providing a second fastener configured to couple to a first extension of the valve stem and compress the first diaphragm against the first extension of the valve stem and form a second seal at the second sealing ring, and configuring the valve system so that formation of the first seal and formation of the second seal are independent of an attachment of a spring element and a pressure element.

### BRIEF DESCRIPTION OF THE DRAWINGS

FIG. 1 is a cross-sectional perspective view of a valve system with an integrated diaphragm according to an exemplary embodiment.

FIG. 2 is an exploded cross-sectional perspective view of a valve system with an integrated diaphragm according to an exemplary embodiment.

FIG. 3 is cross-sectional perspective view of a valve system with an integrated diaphragm according to an exemplary embodiment.

FIG. 4 is an exploded cross-sectional perspective view of a valve system with an integrated diaphragm according to an exemplary embodiment.

FIG. 5 is a detailed view of various sealing elements of the valve system taken generally along lines 5-5 of FIG. 3 according to an exemplary embodiment.

FIG. 6 is a detailed view of various sealing elements of the valve system taken generally along lines 6-6 of FIG. 3 according to an exemplary embodiment.

FIG. 7 is a partial cross-sectional perspective view of a valve system with an integrated diaphragm coupled to a spring element and a pressure element according to an exemplary embodiment.

FIG. 8 is a cross-sectional perspective view of a valve system according to an alternative embodiment.

FIG. 9 is an exploded cross-sectional view of a valve system according to an alternative embodiment.

### DETAILED DESCRIPTION

Before explaining a number of exemplary embodiments of the invention in detail, it is to be understood that the invention is not limited to the details or methodology set forth in the following description or illustrated in the drawings. The invention is capable of other embodiments or being practiced or carried out in various ways. It is also to be understood that the phraseology and terminology employed herein is for the purpose of description and should not be regarded as limiting.

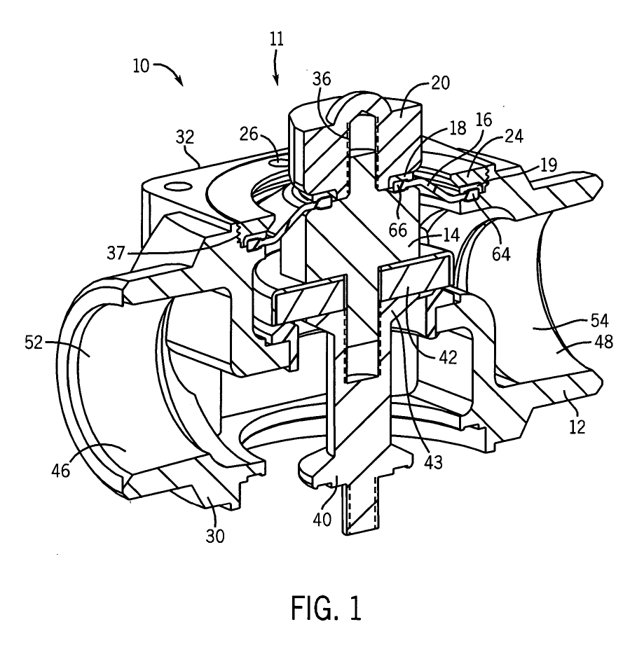

In general, the valve system described in this disclosure comprises a molded reinforced diaphragm having integrated sealing rings (e.g., integrated diaphragm). The diaphragm allows for the axial movement of a valve stem without employing standard valve packing. An exemplary system for sealing a high pressure water regulating valve having an integrated diaphragm will now be discussed. This system is shown in FIG. 1.

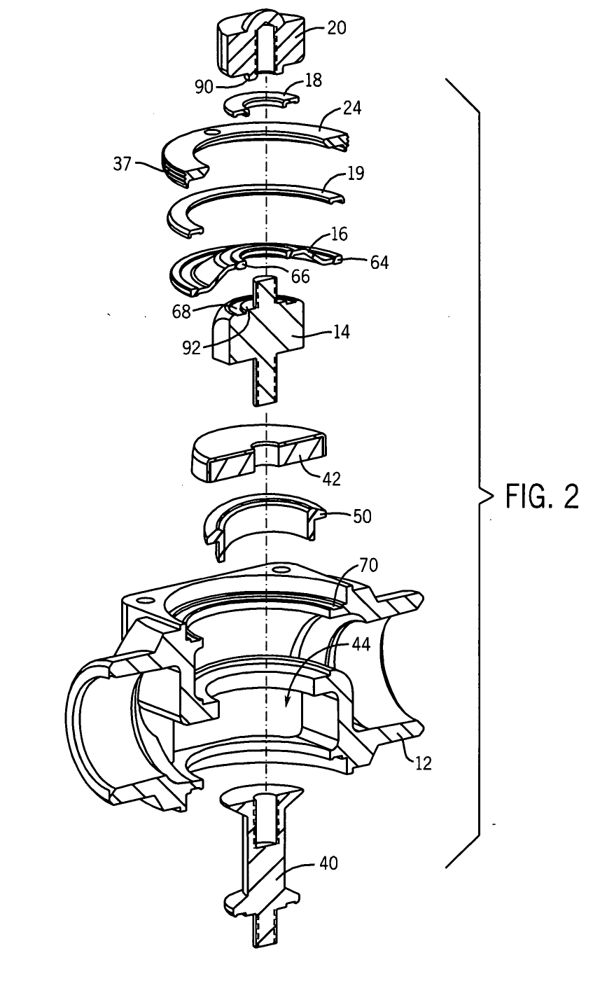

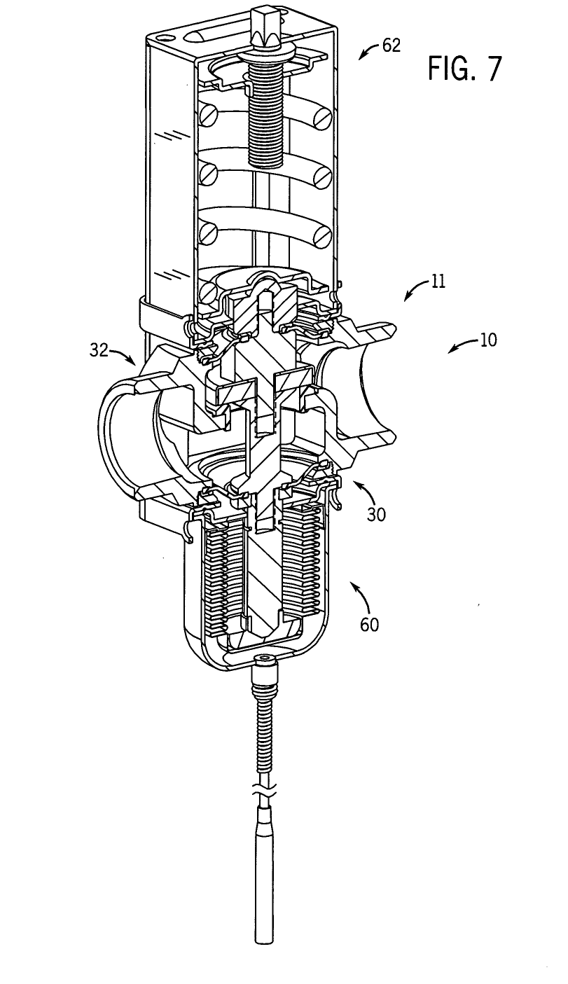

Referring to FIGS. 1 and 2, a high pressure water regulating valve system 10 having an integrated diaphragm 16 is shown according to an exemplary embodiment. System 10 comprises a valve 11 having a valve casting 12 (e.g., housing, valve body, etc.), a seat nut 14, integrated diaphragm 16, an inner compression washer 18, an outer compression washer 19, a guide nut 20, and a compression insert 24 (e.g., threaded insert). A pressure element 60 (shown in FIG. 7) may be attached to valve casting 12 at an end 30 of valve casting 12. A spring element 62 (shown in FIG. 7) may be attached to valve casting 12 at an end 32 of valve casting 12. Valve 11 also includes a valve stem 40 (e.g., rod, shaft, cylinder, etc.) which is configured for axial movement controlled by spring element 62 and pressure element 60. Valve stem 40 is coupled to plunger 42 (e.g., flange) at a first end 43 of valve stem 40.

As shown in FIG. 1, valve 11 in the exemplary embodiment further includes a valve seat 50, an opening 44, an entry chamber 52, and an exit chamber 54. Plunger 42 and seat 50 cooperate to permit or inhibit the flow of a generally fluid substance through valve 11. Plunger 42 contacts valve seat 50 along opening 44 to control the flow of fluid from a first end 46 to a second end 48 of valve casting 12. For example, assuming a pressurized fluid enters valve 11 through entry chamber 52, and further assuming plunger 42 is not in contact with seat 50 (i.e., valve 11 is open), then the fluid is permitted to flow through opening 44 defined by seat 50 into exit chamber 54. Once plunger 42 is brought into contact with seat 50, thus closing valve 11, the fluid is prevented from flowing into exit chamber 54.

In operation, when fluid enters valve 11 through entry chamber 52 with valve 11 in its closed position (as shown in FIG. 1), it exerts a force against plunger 42. Thus, to maintain plunger 42 in contact with seat 50, it is necessary to supply a force of sufficient magnitude in the opposite direction to the force of the fluid to prevent the fluid from escaping into exit chamber 54. Such force is often referred to as “close-off force,” and its value is a function of the pressure driving the fluid through valve 11.

As shown in FIG. 1, seat nut 14 in the exemplary embodiment is configured to engage diaphragm 16. For example, seat nut 14 includes a channel 68 (shown in FIG. 2) that corresponds with an inner sealing ring 66 integrally formed with diaphragm 16. According to various alternative embodiments, seat nut 14 may comprise any suitable machined geometry to provide an adequate seal for the system. Referring to FIG. 1, inner sealing ring 66 is adapted to fit within channel 68 to form an inner seal 80 between diaphragm 16 and seat nut 14. An outer sealing ring 64 is integrally formed with diaphragm 16 around the outer diameter of diaphragm 16. Valve casting 12 includes a channel 70 that is configured to engage with outer sealing ring 64 to form an outer seal 82 between diaphragm 16 and valve casting 12. An exemplary method for securing seals 80 and 82 will now be described.

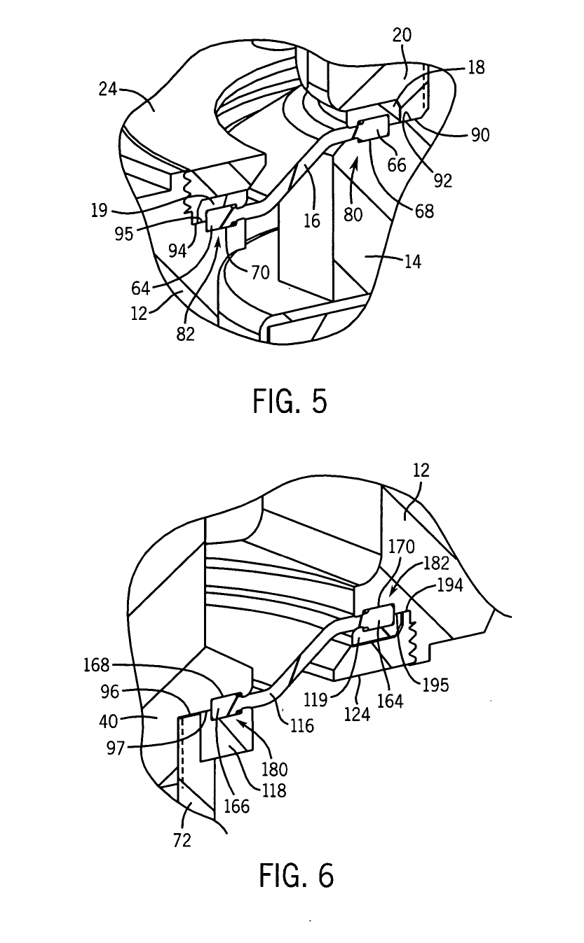

As shown in FIG. 1, according to an exemplary embodiment, diaphragm 16 is placed onto seat nut 14 so that inner sealing ring 66 is received within channel 68. Inner compression washer 18 may be placed over seat nut 14 and onto diaphragm 16 proximate inner sealing ring 66. Washer 18 may be provided to allow guide nut 20 to be tightened until metal to metal contact between guide nut 20 and seat nut 14 is achieved. Guide nut 20 is placed onto washer 18 and seat nut 14 in order to compress inner sealing ring 66 against seat nut 14. Guide nut 20 may be threadably coupled to seat nut 14 along threads 36. According to an exemplary embodiment, guide nut 20 is threaded onto seat nut 14 until a limiting portion of guide nut 20 makes direct contact with seat nut 14. For example, as shown in FIG. 5, guide nut 20 may be threaded onto seat nut 14 until limiting surface 90 of guide nut 20 contacts surface 92 of seat nut 14, thereby preventing guide nut 20 from threadably coupling with seat nut 14 beyond a predetermined position (e.g., a position determined by the machined geometry of guide nut 20 and seat nut 14, including surfaces 90 and 92). As a result, the amount of compression on sealing ring 66 is consistent thereon and determined by geometry rather than manufacturing (e.g., torque values, sequence of bolt tightening, etc.). By threading guide nut 20 onto seat nut 14, inner compression washer 18 is forced against inner sealing ring 66 of diaphragm 16. This secures inner sealing ring 66 within channel 68 of seat nut 14, thereby creating and securing inner seal 80. Washer 18 allows guide nut 20 to be tightened without causing diaphragm 16 to turn or altering seal 80. Accordingly, the formation of seal 80 may be independent of the attachment of a spring, fastener, or other housing (e.g., spring element 62 shown in FIG. 7) at end 32 of valve casting 12. Once guide nut 20 has been threadably coupled to seat nut 14, spring element 62 or other structure or device may be coupled to the system at end 32 and is not required to maintain seal 80.

As explained above, outer seal 82 is formed between diaphragm 16 and valve casting 12 by means of sealing ring 64 integrally formed in diaphragm 16 engaging channel 70. Seal 82 may also include outer compression washer 19 situated between diaphragm 16 and compression insert 24 to allow compression insert 24 to be tightened and/or turned until contact occurs between valve casting 12 and compression insert 24. In addition, washer 19 allows compression insert 24 to be tightened without turning or contacting diaphragm 16. In order to tighten the system, compression insert 24 may be threadably coupled to valve casting 12 (e.g., at threads 37), thereby providing tensioning or compression force against washer 19 and diaphragm 16. According to an exemplary embodiment, compression insert 24 is threaded onto valve casting 12 until a limiting portion of compression insert 24 makes direct contact with valve casting 12. For example, as shown in FIG. 5, compression insert 24 may be threaded onto valve casting 12 until limiting surface 94 of compression insert 24 contacts surface 95 of valve casting 12, thereby preventing compression insert 24 from threadably coupling with valve casting 12 beyond a predetermined position (e.g., a position determined by the machined geometry of compression insert 24 and valve casting 12, including surfaces 94 and 95). As a result, the amount of compression on sealing ring 64 is consistent thereon and determined by geometry rather than manufacturing (e.g., torque values, sequence of bolt tightening, etc.). The compression force secures outer sealing ring 64 within channel 70, thereby forming outer seal 82. Accordingly, the formation of outer seal 82 may occur independent of the attachment of a spring, fastener, or other housing (e.g., spring element 62 shown in FIG. 7) at end 32 of valve casting 12. Once compression insert 24 has been threadably coupled to valve casting 12, spring element 62 or other structure or device may be coupled to the system at end 32 and is not required to maintain seal 82.

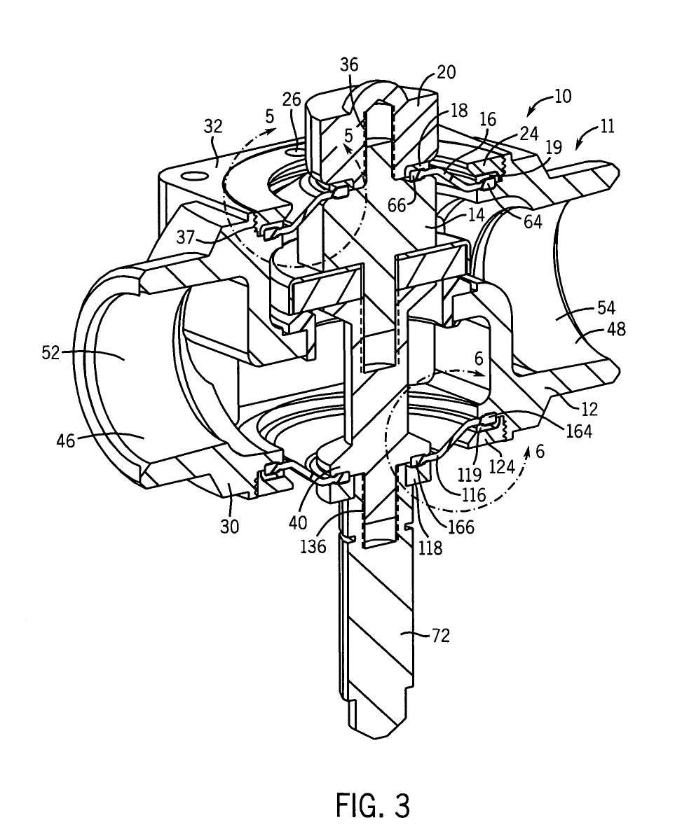

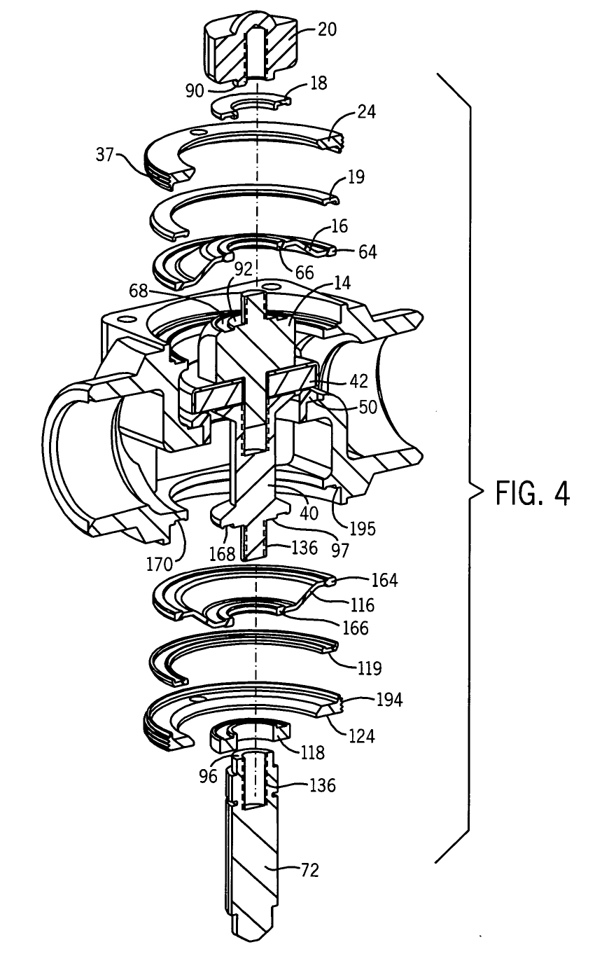

According to an exemplary embodiment, a similar arrangement can be provided at end 30 of valve casting 12. For example, as shown in FIGS. 3 and 4, a diaphragm 116 is placed onto valve stem 40 so that an inner sealing ring 166 engages valve stem 40. Valve stem 40 may be configured to include a channel 168 that corresponds to inner sealing ring 166, which may be integrally formed in diaphragm 116. An inner compression washer 118 may be placed onto diaphragm 116 proximate inner sealing ring 166. A bellows push rod 72 may be threadably coupled to valve stem 40 along threads 136. According to an exemplary embodiment, bellows push rod 72 is threaded onto valve stem 40 until a limiting portion of bellows push rod 72 makes direct contact with valve stem 40. For example, as shown in FIG. 6, bellows push rod 72 may be threaded onto valve stem 40 until limiting surface 96 of bellows push rod 72 contacts surface 97 of valve stem 40, thereby preventing bellows push rod 72 from threadably coupling with valve stem 40 beyond a predetermined position (e.g., a position determined by the machined geometry of bellows push rod 72 and valve stem 40, including surfaces 96 and 97). As a result, the amount of compression on sealing ring 166 is consistent thereon and determined by geometry rather than manufacturing (e.g., torque values, sequence of bolt tightening, etc.). By threading bellows push rod 72 onto valve stem 40, inner compression washer 118 is forced against inner sealing ring 166 of diaphragm 116. This secures inner sealing ring 166 within channel 168 of valve stem 40, thereby creating an inner seal 180. Accordingly, the formation of seal 180 may occur independent of the attachment of a pressure device, fastener, or other housing (e.g., pressure element 60 shown in FIG. 7) at end 30 of valve casting 12. Once bellows push rod 72 has been threadably coupled to valve casting 12, pressure element 60 or other structure or device may be coupled to the system at end 30 and is not required to maintain seal 180. According to alternative embodiments, any suitable means for creating a seal between the diaphragm and the valve stem may be utilized.

Diaphragm 116 may also form an outer seal 182 with valve casting 12. Outer seal 182 may be formed between an outer sealing ring 164 integrally formed in diaphragm 116 and a channel 170 in valve casting 12. An outer compression washer 119 may be placed between diaphragm 116 and compression insert 124 to allow compression insert 124 to be tightened and/or turned until contact between valve casting 12 and compression insert 124. In addition, washer 119 allows compression insert 124 to be tightened without turning or contacting diaphragm 116. In order to tighten the system, compression insert 124 may be threadably coupled to valve casting 12, thereby providing a tensioning or compression force against washer 119 and diaphragm 116. According to an exemplary embodiment, compression insert 124 is threaded onto valve casting 12 until a limiting portion of compression insert 124 makes direct contact with valve casting 12. For example, as shown in FIG. 6, compression insert 124 may be threaded onto valve casting 12 until limiting surface 194 of compression insert 124 contacts surface 195 of valve casting 12, thereby preventing compression insert 124 from threadably coupling with valve casting 12 beyond a predetermined position (e.g., a position determined by the machined geometry of compression insert 124 and valve casting 12, including surfaces 194 and 195). As a result, the amount of compression on sealing ring 164 is consistent thereon and determined by geometry rather than manufacturing (e.g., torque values, sequence of bolt tightening, etc.). The compression force secures outer sealing ring 164 within channel 170, thereby forming seal 182. Accordingly, the formation of seal 182 may occur independent of the attachment of a pressure device, fastener, or other housing (e.g., pressure element 60 shown in FIG. 7) at end 30 of valve casting 12. Once compression insert 124 has been threadably coupled to valve casting 12, pressure element 60 or other structure or device may be coupled to the system at end 30 and is not required to maintain seal 182.

According to an exemplary embodiment shown in FIG. 1, diaphragms 16 and 116 may have an overall curved and/or convoluted shape which produces various features. For example, the curved shape provides for axial movement of the diaphragm when seals 80, 82, 180 and 182 are created (e.g., axial movement proximate inner sealing rings 66 and 166). This configuration minimizes stretching (as compared to various other diaphragms such as flat diaphragms) and also prevents the sealing rings from being pulled out from the mating geometry provided in the various components of the system. According to alternative embodiments, the geometry of the system and configuration of the components such as the diaphragms may vary from what is shown and described.

According to various exemplary embodiments, the assemblies and components of the system may be constructed from various different materials. In addition, the assemblies and components of the system may be constructed from materials that are durable and substantially non-corroding. For example, a variety of plastics (e.g., high-impact), polymers, reinforced rubber, etc. may be used for construction or assembly of the diaphragm. Using rubber or plastic offers several advantages including that the diaphragm may be constructed in a variety of different colors, surface finishes, textures, opacity, etc. According to various exemplary embodiments, a variety of suitable materials may be used for other components (such as the compression insert, guide nut, valve casting, etc.) of the system, including metals, engineered plastics, alloys, composites, aluminum, stainless steel, etc. Further, various parts of the system may be constructed and assembled as a single integrally formed piece or may be constructed and assembled from multiple parts.

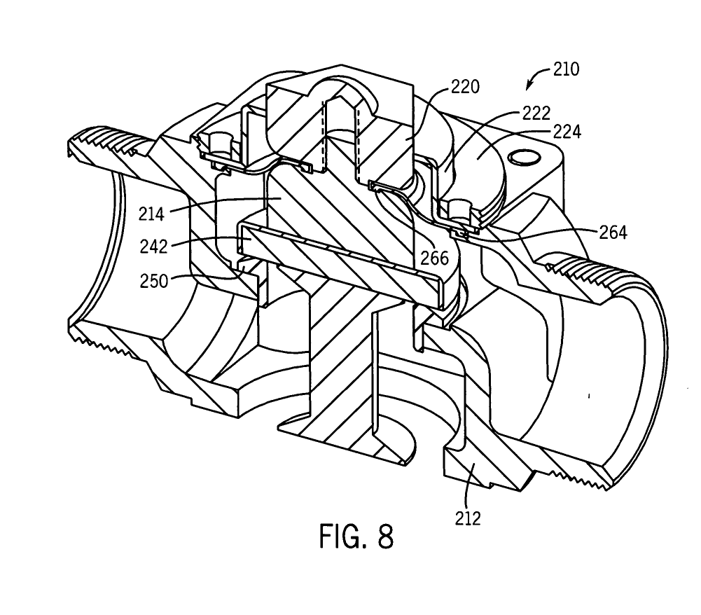

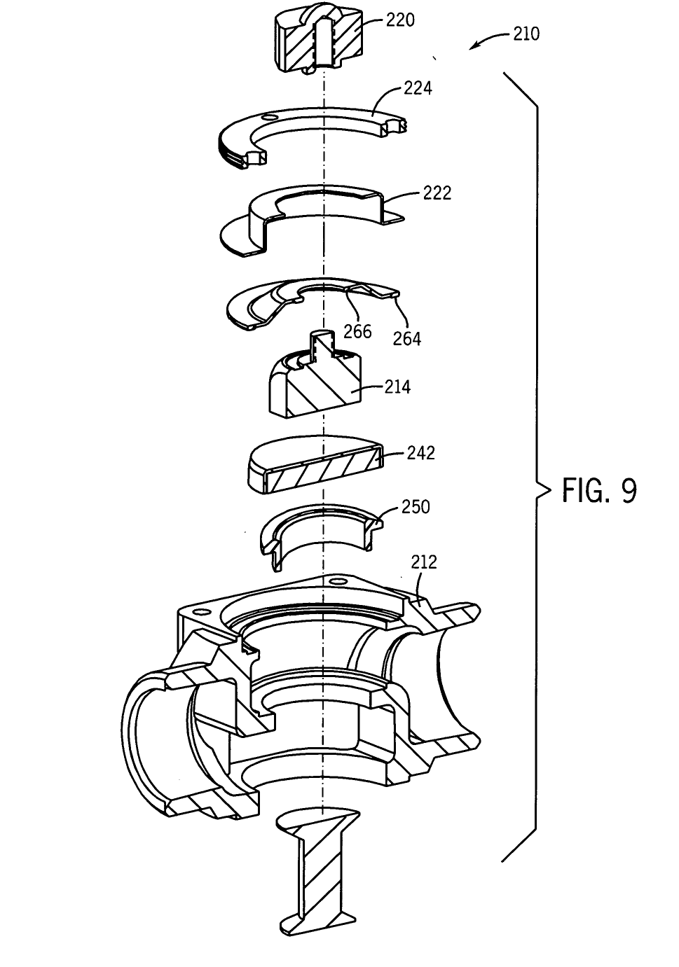

Referring now to FIGS. 8 and 9, another embodiment of a high pressure water regulating valve system 210 is shown and described. Valve system 210 is substantially identical to the exemplary embodiment of valve system 10 (FIG. 1 through 7) described above except that one or more washers may be replaced by and/or used in combination with parts such as guide 222. For brevity, elements of valve system 210 that correspond to like elements in valve system 10 described above are identified by the same reference numerals but increased by 200. Guide 222 may function similar to a washer by allowing a fastener to compress the diaphragm without turning and/or altering the seals. For example, guide 222 may be configured to fit over a guide nut 220. A compression insert 224 may then be threadably coupled to valve casting 212. In doing so, compression insert 224 applies a compression force to guide 222 which is pushed against an outer sealing ring 264. According to other exemplary embodiments, compression insert 224 may also apply a compression force on guide 222, guide nut 220, and inner sealing ring 266. As described above, system 210 may also include a seat nut 214, a plunger 242, and a valve seat 250. According to various alternative embodiments, any other suitable configurations and elements may be used.

It is important to note that the above-described embodiments are illustrative only. Although the invention has been described in conjunction with specific embodiments thereof, those skilled in the art will appreciate that numerous modifications are possible without materially departing from the novel teachings and advantages of the subject matter described herein. For example, the diaphragm may include more or less than two integral sealing rings as described herein. In addition, the diaphragm may engage the valve casting, valve stem, and/or other elements at different locations or according to different configurations. Accordingly, these and all other such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangements of the preferred and other exemplary embodiments without departing from the spirit of the present invention.

1. A system for regulating fluids comprising:
a valve comprising a housing and a valve stem;
a diaphragm positioned proximate a first end of the valve and having a first sealing ring; and
a first compression insert configured to threadably couple to the housing of the valve;
wherein the housing of the valve is configured to receive at least a portion of the first sealing ring; and
wherein the first compression insert is configured to compress the first sealing ring received within the housing of the valve by coupling to the housing of the valve.

2. The system of claim 1 wherein the first sealing ring is integrally formed with the diaphragm.

3. The system of claim 2 wherein the first sealing ring is positioned proximate an outer portion of the diaphragm.

4. The system of claim 1 further comprising:
a seat nut coupled to the valve stem and configured to receive at least a portion of a second sealing ring of the diaphragm; and
a guide nut configured to couple to the seat nut;
wherein the guide nut is configured to compress the second sealing ring received within the seat nut by coupling to the seat nut.

5. The system of claim 4 wherein the second sealing ring is integrally formed with the diaphragm.

6. The system of claim 5 wherein the second sealing ring is positioned proximate an inner portion of the diaphragm.

7. The system of claim 4 wherein a first seal is formed between the valve housing and the first sealing ring.

8. The system of claim 7 wherein a second seal is formed between the seat nut and the second sealing ring.

9. The system of claim 8 wherein the diaphragm comprises a generally curved shape between the first sealing ring and the second sealing ring to allow axial movement of the diaphragm when the first seal and the second seal are formed.

10. The system of claim 9 wherein a force applied by the first compression insert to the first sealing ring creates the first seal between the diaphragm and the housing of the valve and a force applied by the guide nut to the second sealing ring creates the second seal between the seat nut and the diaphragm.

11. The system of claim 10 wherein the first and second seals are formed independent of an attachment of a spring element at the first end of the valve.

12. The system of claim 10 wherein the force applied against the second sealing ring to create the second seal is limited by contact between a limiting surface of the guide nut and a limiting surface of the seat nut at a predetermined location according to machined geometry of the guide nut and the seat nut.

13. The system of claim 10 wherein the force applied against the first sealing ring to create the first seal is limited by contact between a limiting surface of the compression insert and a limiting surface of the valve casting at a predetermined location according to machined geometry of the compression insert and the valve casting.

14. The system of claim 1 further comprising an outer compression washer positioned between the diaphragm and the first compression insert.

15. The system of claim 14 further comprising an inner compression washer positioned between the guide nut and the diaphragm.

16. The system of claim 15 wherein the outer compression washer is interposed between the first compression insert and the diaphragm.

17. The system of claim 15 wherein the inner compression washer is interposed between the guide nut and the diaphragm.

18. The system of claim 1 wherein the housing of the valve comprises a channel for receiving the second sealing ring.

19. The system of claim 1 wherein the seat nut comprises a channel for receiving the first sealing ring.

20. The system of claim 1 further comprising a spring element coupled to the valve at the first end of the valve.

21. The system of claim 20 wherein the spring element is removable from the first end of the valve without affecting the diaphragm and formation of a seal.

22. A system for regulating fluids comprising:
a valve comprising a housing and a valve stem;
a diaphragm positioned proximate a first end of the valve and having a first sealing ring; and
a seat nut coupled to the valve stem and configured to receive at least a portion of the first sealing ring;
wherein the guide nut is configured to compress the first sealing ring received within the seat nut by coupling to the seat nut.

23. The system of claim 22 wherein the first sealing ring is integrally formed with and proximate an inner portion of the diaphragm.

24. The system of claim 23 wherein a first seal is formed between the seat nut and the first sealing ring.

25. The system of claim 24 wherein force applied against the first sealing ring to create the first seal is limited by contact between a limiting surface of the guide nut and a limiting surface of the seat nut at a predetermined location according to machined geometry of the guide nut and the seat nut.

26. A system for regulating fluids comprising:
a valve comprising a housing and a valve stem;
a diaphragm positioned proximate a first end of the valve and having a first sealing ring;
a first compression insert configured to threadably couple to the housing of the valve; and
a push rod configured to threadably couple to the valve stem;
wherein the diaphragm comprises a first sealing ring;
wherein the valve stem is configured to receive at least a portion of the first sealing ring; and
wherein the push rod is configured to compress the first sealing ring received within the valve stem by coupling to the valve stem.

27. The system of claim 26 further comprising:
and a second sealing ring;
wherein the housing of the valve is configured to receive at least a portion of the second sealing ring; and
wherein the compression insert is configured to compress the second sealing ring received within the housing of the valve by coupling to the housing of the valve.

28. The system of claim 27 wherein a first seal is formed between the valve stem and the first sealing ring and a second seal is formed between the valve housing and the second sealing ring.

29. The system of claim 28 further comprising a pressure element coupled to the valve at the first end of the valve.

30. The system of claim 29 wherein the pressure element may be removed from the valve without affecting the first and second seals.

31. The system of claim 28 wherein the first seal and the second seal exist independent of an attachment of a pressure element at the first end of the valve.

32. A system for regulating fluids comprising:
a valve comprising a housing and a valve stem configured to regulate fluid flow through the valve;
a first diaphragm positioned proximate a first end of the valve and having a first sealing portion and a second sealing portion;
a first fastener configured to couple to the housing of the valve and compress the first diaphragm against the housing of the valve and form a first seal at the first sealing portion;
a second fastener configured to couple to a first extension of the valve stem and compress the first diaphragm against the first extension of the valve stem and form a second seal at the second sealing portion.

33. The system of claim 32 further comprising:
a second diaphragm positioned proximate a second end of the valve and having a third sealing portion and a fourth sealing portion;
a third fastener configured to couple to the housing of the valve and compress the second diaphragm against the housing of the valve and form a third seal at the third sealing portion; and
a fourth fastener configured to couple to a second extension of the valve stem and compress the second diaphragm against the second extension of the valve stem and form a fourth seal at the fourth sealing portion.

34. The system of claim 33 wherein the first, second, third, and fourth fasteners each include a limiting surface that limits coupling according to a machined geometry.

35. The system of claim 33 wherein the first sealing portion is a first sealing ring, the second sealing portion is a second sealing ring, the third sealing portion is a third sealing ring, and the fourth sealing portion is a fourth sealing ring.

36. The system of claim 35 wherein the first and second sealing rings are integrally formed with the first diaphragm, and the third and fourth sealing rings are integrally formed with the second diaphragm.

37. The system of claim 36 wherein the first diaphragm comprises a generally curved shape between the first sealing ring and the second sealing ring to allow axial movement of the first diaphragm when the first seal and the second seal are formed.

38. The system of claim 33 wherein the first fastener is a first compression insert and the second fastener is a guide nut.

39. The system of claim 33 wherein the third fastener is a compression insert and the fourth fastener is a push rod.

40. The system of claim 33 wherein the housing of the valve is configured to receive the second sealing portion of the first diaphragm and the fourth sealing portion of the second diaphragm.

41. The system of claim 40 further comprising a spring element coupled to the first end of the valve and a pressure element coupled to the second end of the valve.

42. The system of claim 41 wherein the spring housing and the pressure element may be removed from the valve without affecting the first seal, the second seal, the third seal, and the fourth seal.

43. A system for regulating fluids comprising:
a valve comprising a housing and a valve stem configured to regulate fluid through the valve;
a diaphragm positioned proximate a first end of the valve and having a first sealing portion and a second sealing portion;
a first fastener configured to couple to the housing of the valve and compress the diaphragm against the housing of the valve and form a first seal at the first sealing portion; and
a second fastener configured to couple to an extension of the valve stem and compress the diaphragm against the extension of the valve stem and form a second seal at the second sealing portion.

44. The system of claim 43 wherein the first and second fasteners each include a limiting surface that limits coupling according to a machined geometry.

45. The system of claim 44 wherein the first sealing portion is a first sealing ring and the second sealing portion is a second sealing ring.

46. The system of claim 45 wherein the first and second sealing rings are integrally formed with the diaphragm.

47. A method for producing a valve system that forms a seal without attachment of a pressure element and spring element, the method comprising:
providing a valve having a housing and a valve stem configured to regulate fluid flow through the valve;
providing a first diaphragm positioned proximate a first end of the valve and having a first sealing ring and a second sealing ring;
providing a first fastener configured to couple to the housing of the valve and compress the first diaphragm against the housing of the valve and form a first seal at the first sealing ring;
providing a second fastener configured to couple to a first extension of the valve stem and compress the first diaphragm against the first extension of the valve stem and form a second seal at the second sealing ring; and
configuring the valve system so that formation of the first seal and formation of the second seal are independent of an attachment of a spring element and a pressure element.

48. The method of claim 47 further comprising forming the first sealing ring and the second sealing ring integrally with the first diaphragm.

49. The method of claim 48 further comprising providing a second diaphragm positioned proximate a second end of the valve and having a third sealing ring and a fourth sealing ring.

50. The method of claim 49 further comprising providing a third fastener configured to couple to the housing of the valve and compress the second diaphragm against the housing of the valve and form a third seal at the third sealing ring, and providing a fourth fastener configured to couple to a second extension of the valve stem to compress the second diaphragm against the second extension of the valve stem and form a fourth seal at the fourth sealing ring, wherein formation of the third seal and formation of the fourth seal are independent of an attachment of the spring element and the pressure element.
